(19) United States
(12) Patent Application Publication
(10) Pub. No.: US 2006/0219184 A1
(43) Pub. Date: Oct. 5, 2006

(54) Compartmentalized Plastic Bags That Deliver Stress-Reducing Chemicals to Fish During Transport or Treatment

(76) Inventors: Charles Lindsay Wilson, Shepherdstown, WV (US); Erik Alan Burchard, Hagerstown, MD (US); Paul Arthur Peach, Hedgesville, WV (US)

Correspondence Address: CHARLES LINDSAY WILSON, BOX 1194, SHEPERDSTOWN, WV, 25443, US

(21) Appl. No.: 11/277,713

(22) Filed: Mar. 28, 2006

Related U.S. Application Data
(60) Provisional application No. 60/594,370, filed on Apr. 1, 2005.

(51) Int. Cl. A01K 63/02

(52) U.S. Cl. 119/203

(57) ABSTRACT

The present invention provides a unique means of adding stress-reducing chemicals to plastic fish transport and treatment bags. The exact dosage of the stress-reducing chemical (s) is added to the water in fish-transport and treatment bags without individuals having to handle or measure the chemicals. This is accomplished by sequestering the chemical (s) in a porous compartment in the fish-transport or treatment plastic bag. The chemical (s) flow out of the compartment into the bag in an appropriate dosage once water is added to the fish-transport or treatment bag.

### BACKGROUND

The present invention discloses a method of automatically delivering stress-reducing chemicals to water used to transport or treat fish in plastic bags. It eliminates the need to handle, precisely measure, and apply these chemicals.

Aquaculture worldwide is a 52.8 billion dollar industry. Plastic bags provide an important means for transport in the commercial fish trade. Fish are transported in plastic bags by fish hobbyists, fish farmers, and sellers of fish bait. The ornamental fish trade industry within the United States is valued at 3 billion dollars. Sales of ornamental fish exports in the U.S. in 2004 were placed by the USDA at 10 million dollars. Sales of imported ornamental fish were estimated at around 48 million. Annual sales of both wild and cultured baitfish in the U.S. and Canada are estimated to be over one billion dollars.

Fish, shellfish, and plants are often transported in sealed plastic bags containing water and pure oxygen [U.S. Pat. No. 2,949,882]. Plastic bags are partially filled with water and air is squeezed out of the top of the bag and replaced with pure oxygen. The bag is then placed into an insulated container and finally into a cardboard shipping box and shipped. These procedures have a number of advantages in that small fish and fry are often damaged when shipped in large tanks but not in plastic bags. Second, bag shipments by ground offer economic advantages to shipping by air freight or bus.

Water quality while fish are being transported is paramount to their survival and health. Important parameters to be considered during transport are temperature, dissolved oxygen, pH, carbon dioxide, ammonia, and the salt balance of the fish's blood. Ice or blue ice packs are often used during transport to keep the fish cool and thus reduce their respiration and activity.

Fish become stressed when they are unable to maintain a normal physiologic state because of various factors adversely affecting their well-being. One of the most important factors in water that affects fish stress and enhances their survival is the quantity of dissolved oxygen (DO). It is common to fill the headspace above the water used to ship fish with pure oxygen. This oxygen is then dissolved into the water during transport. A 75% volume of oxygen is needed in the bag during transport to provide adequate diffusion of oxygen at the surface of the water.

The quantity of hydrogen ions (H⁺) in the water used to transport fish is critical. The scale for measuring the degree of acidity is called the pH scale, which ranges from 1 to 14 with 7 being neutral. The acceptable range for fish growth is between pH 6.5-9.0. The pH of water is influenced by the alkalinity (buffering capacity) and the amount of free carbon dioxide in the water.

When fish are transported in water in plastic bags they produce carbon dioxide as a product of respiration. Carbon dioxide reacts with water to form carbonic acid (H₂CO₃) which decreases the pH of the water. High levels of carbon dioxide (greater than 20 ppm) will interfere with the oxygen uptake in the fish's blood, while changes in pH further stress the fish especially if such changes are allowed to occur rapidly.

Ammonia buildup occurs in transport water as a result of bacterial action on fish waste excreted in the water. Ionized and un-ionized forms of ammonia occur in the transport water. The un-ionized ammonia (NH₃) is extremely toxic, with the level of this toxicity being greatly enhanced with increasing pH, while the ionized form (NH₄⁺) is not. It is recommended that total ammonia concentrations greater than 5 ppm be viewed with caution. Ammonia toxicity during transport can be controlled by maintenance of an acceptable pH range, temperature range, and by avoiding feeding the fish 48-72 hours prior to shipment to reduce the amount of waste excreted.

Some fish stress problems that occur from water used to transport fish in plastic bags can be alleviated with chemical additives. Presently, these chemicals are added to the water in the form of dissolvable tablets, liquids, and powders. A person is required to handle these compounds and measure the amount needed for the quantity of transport water in the bag. If proper measurements are not made, the addition of these compounds may result in toxicity to the fish or ineffective dosages.

The most common chemical other than oxygen added to water in bags used to transport fish is salt (NaCl). Fish have a blood salt concentration higher than the salt of most water used to transport fish. Non-iodized salt should be used that contains non anti-caking compounds. Canning salt is an example. Concentrations of 5,000 ppm (0.590) are commonly used for water in fish transport bags.

If transport water alkalinity is less than 100 ppm, some type of buffering compound should be added to fish transport water. Buffered water will help remove free carbon dioxide which causes an increase in acidity. Sodium bicarbonate (Na₂CO₃) is a compound commonly added to transport water as a buffer.

It has been found that the addition of a chemical anesthetic may be beneficial in reducing stress to fish transported in plastic bags. The Food and Drug Administration (FDA) has approved Finquel (tricaine-methanesulfonate). Finquel is used at a rate of 0.1-0.5 g/gal of water.

Fish are susceptible to a number of diseases, especially under the stress-inducing conditions that are often observed during transport. One of the most common diseases of fish is caused by Ichthyophyhirius multifiliis (White Spot or “Ich”). Diseased fish are generally isolated and treated with various chemicals including copper sulfate, potassium permanganate, formalin, and salt. A variety of antibiotics are used to combat fish diseases including acriflavin, nitrofurans, oxytetracycline, kanamycin, chloramphenical, sulfanomides. They are applied as a dip, topically, via injection, or as components of feed. In some cases stress-reducing added to fish transport and treatment bags can present a hazard to the individual handling them.

Thomas [U.S. Pat. No. 2,949,882] describes the basic plastic bag configuration used to this day to transport fish. A plastic bag is filled with water leaving a headspace that is subsequently filled with oxygen prior to sealing the bag. A variety of fish transport bags have been compartmentalized for various purposes. Tomohide [JP 2004024122] discloses a compartmentalized fish vinyl bag that is divided horizontally into multiple levels to segregate and ship flatfish such as fluke and flounder. Yoshiaki [JP 184511] discloses a transport bag made of rubber or vinyl resin that contains a compartment to immobilize fish during transport. Brooks [U.S. Patent No. 3,565,041] discloses a plastic bag for transporting fish that has a bottom with an angle greater than 90°. Such a configuration eliminates the stress on fish caused when they become wedged in corners of conventional bags used to transport fish. Bodell [U.S. Pat. No. 3,168,887] discloses a fish transport bag fabricated out of silicone rubber with high oxygen and carbon dioxide permeability. The favorable oxygen and carbon dioxide exchange through the wall of the bag reduces stress in the fish during transport. Kamihata et al. [U.S. Pat. No. 6,354,246 B1] disclose a cuplike container for transporting fish. The top of the container is covered with an air permeable and water impermeable materials this is held on the container with a removable cap. Another embodiment of the invention (FIG. 5) attaches a gas permeable and water impermeable material to the side of a plastic bag used to transport fish. McKellar et al. [U.S. Pat. No. 5,050,535] disclose a fish transport bag that includes a multi-layered wall having a semi-permeable membrane mounted therein that allows air to pass into and out of the bag. The bag wall contains a layer opaque to sunlight and an insulating layer as well. This configuration reduces oxygen and temperature stress to fish during transported.

Yoshida et al. [U.S. Pat. No. 6,306,352 B1 ] describe a method of generating oxygen and absorbing carbon dioxide in order to reduce stress on fish transported in plastic bags. The chemicals used to generate oxygen and absorb carbon dioxide are placed in a package composed of multi-microporous plastic film or non-woven fabrics such as Tyvek (U.S. manufactured by DuPont). The package containing the oxygen generating and carbon dioxide absorbing chemicals is attached to the inside of the fish transport bag with adhesive materials or adhesive tapes.

Unlike our invention, all chemical exchange between the package of chemicals and the water in the fish transport bag in Yoshida et al. [U.S. Pat. No. 6,306,352 B1] invention takes place through microporous plastic film in which the maximum pore size is 2 μm. Such porosity allows the exchange of gases such as carbon dioxide and oxygen between the water in the fish transport bag and the package containing oxygen generating and carbon dioxide chemicals, but does not allow the compete dissolution of compounds from the chemical-containing package into the water of the fish transport bag. The pore size between the stress-reducing chemical-containing compartment in our invention [0.75-1.2 mm in diameter] allows for such complete dissolution.

Our invention is distinct from that of Yoshida et al. [U.S. Pat. No. 6,306,352 B1] in that the stress-reducing chemicals are not placed in a package that is attached to the inside of the bag but rather the fish stress-reducing chemicals are contained in a compartment that is a contiguous part of the fish transport bag. Such a configuration allows the free flow of water and soluble chemicals through the pores [0.75-1.2 mm in diameter] and eliminates the possibility a chemical-containing package might become detached from the fish transport bag.

The package for the stress-reducing compounds in the present invention allows for the complete solubilization or mixing of fish stress-reducing compounds placed in the bag compartment through pores 4 [0.75-1.2 mm in diameter] connecting the chemical-containing compartment 3 with water that is added to the fish transport bag. The invention disclosed by Yoshida et al. allows only those gaseous and solubilized compounds capable of passing through a microporus plastic film with a maximum pore size of 2 μm to enter.

In conclusion, plastic fish transport bags have been manufactured in a variety of ways to create conditions that will enhance fish survivability. None of the previous art, however, discloses a system which has the combined characteristics of the present invention which are to (1) deliver precise amounts of stress-reducing chemicals to water used in plastic bags used for fish transport; (2) and, eliminate the need for practitioners of this invention to handle fish stress-reducing chemicals. Also, none of the previous art discloses a fish treatment bag that will: (1) deliver precise amounts of disease control chemicals; and (2) eliminate the need for practitioners of this art to handle or measure such chemicals.

### SUMMARY OF INVENTION

A variety of stress-reducing chemicals are added to the water in plastic bags used to transport fish. They are added to accomplish a variety of purposes such as oxygen generation, pH control, ammonia control, salt control, and disease control.

In order to add these chemicals to water in fish transport bags, individuals must first handle the compounds and measure them precisely because an overdose may result in toxicity to the fish. An under-dose may result in the chemicals being ineffective.

The present invention overcomes the above disadvantages inherent in present methods of applying chemicals to fish transport and treatment bags to reduce stress. It allows the application of these chemicals without the applicator having to handle them. It also provides a means of administering the chemicals in precise dosages without measurement of the chemicals being required. This avoids any possible toxicity to the individual applying the chemical to the fish transport or treatment bag.

Specifically, this invention accomplishes the above by compartmentalizing concentrated fish stress-reducing chemicals 3 in a compartment 1, 2 within fish transport or treatment plastic bags. The compartment containing the concentrated stress-reducing chemicals is interconnected to the inner space of the fish transport and treatment bag with pores 4. A measured amount of water is added to the fish transport or treatment bag which can be regulated by a fill line placed on the side of the bag. When water enters the bag it flows into the compartment containing the fish stress-reducing chemicals through the pores 4. The amount of stress reducing chemicals in the compartment is precisely measured so that once these compounds diffuse and mix with the water in the bag, an optimum dosage of the stress-reducing chemicals will exist in the water used to transport or treat fish.

One or more of a variety of stress-reducing chemicals can be placed in the fish-transport bag to reduce any of a number of stressors experienced by fish during transport in plastic bags. This is accomplished by simply adding a precise amount of water to a bag that contains the precise dosage(s) of the stress-reducing chemical(s) in its chemical-containing compartment.

### BRIEF DESCRIPTION OF FIGURES

FIG. 1. Overall view of the bottom portion of a plastic fish transport or treatment bag showing the location of the chemical-containing compartment (1, 2).

FIG. 2. Magnified cross-sectional view of the corner of a fish transport or treatment bag showing the compartment containing the chemicals 3 and pores 4 between the compartment and the interior of the bag.

FIG. 3. Magnified longitudinal view of the bottom of a fish transport or treatment bag showing the compartment with the chemicals 3 and the pores 4 between the compartment and the interior of the bag.

### DETAILED DESCRIPTION OF THE INVENTION

Fish transport bags are defined as plastic bags used to transport fish from one location to another. Fish treatment bags are defined as plastic bags in which fish are placed for a prescribed period to isolate and treat them for a stress problem such as disease. Once treated fish are returned to their original environment. This invention describes a system whereby plastic bags can be fabricated to serve both to transport fish and to treat them.

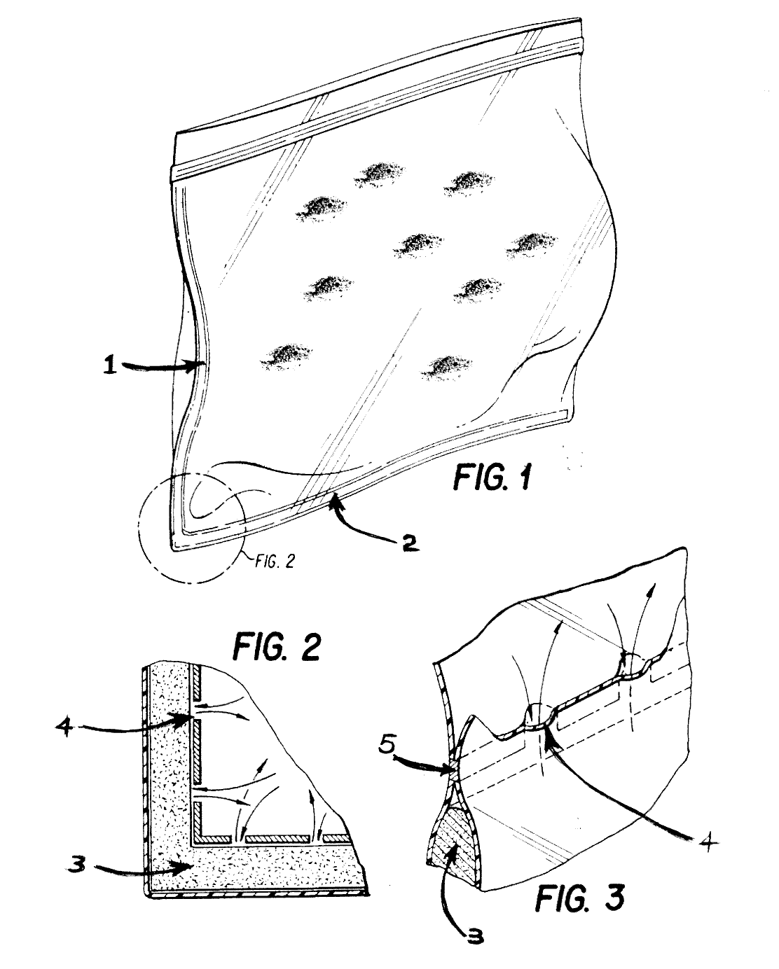

The present invention sequesters stress-reducing chemicals 3 in plastic fish transport and treatment bags (FIGS. 1, 2, 3) in a manner that allows their release into the water added to the bag for fish transport or treatment. This is accomplished by creating a compartment 1, 2 in fish transport and treatment bag that has pores (FIGS. 1, 2, 3). A partition between the stress-reducing compounds and inner bag is created by differentially heat sealing 5 plastic between the compartment and the inner bag. The stress-reducing compounds in the compartment 1, 2 of fish-transport or treatments bags remain un-reactive in the bag compartment (FIG. 1) until water is added to the bag. At that time water enters the pores 4 of the compartment where the stress-reducing chemicals 3 are located and solubilizes them. Through diffusion, equilibrium is reached between the compounds in the compartment and the interior of the bag, resulting in water that is chemically homogeneous.

Dosages of the stress-reducing chemicals 3 in the plastic fish transport and fish treatment bags can be precisely measured to deliver a desired concentration in proportion to the volume of water added to the bag. This eliminates errors in measurement and also prevents an individual using the bag from coming in contact with concentrated forms of the stress-reducing chemicals.

In one embodiment of this invention, the stress-reducing compounds in the compartment 3 of the fish transport or treatment bag can be made into a time-release formulation that will release active chemicals into the bag water in desired concentrations for prescribed periods. Such formulations are known to the art and can involve such time-release carriers as charcoal, zeolite, silica gel, starches, polydextrins, and plastics.

In another embodiment of the invention, oxygen-generating compounds such as sodium percarbonate are placed in the compartment of the bag 1, 2. When water is added these compounds will help maintain dissolved oxygen (DO) levels in the water of the fish transport bags at a level optimum for fish. The oxygen-generating chemicals can be made into time-release formulations to maintain a continuous oxygen supply over a prolonged period.

In still another embodiment of this invention, stress-reducing chemicals 3 such as tranquilizers like Finquel (tricaine-methanesulfonate) are placed in the compartment at concentrations that will deliver a desired dosage in the water of the fish-transport or fish treatment bag. Time-release formulations of these tranquilizers are also a part of this invention.

In another embodiment of this invention, antimicrobial and antibiotic compounds to control fish diseases and parasites such as acriflavin, nitrofurans, oxytetracycline, kanomycin, chloramphenical, sulfanomides, salt, iodine, malachite green, methylene blue, formalin, sodium percarbonate, and garlic extract are placed in the bag compartment 1, 2 to deliver prescribed dosages of these chemicals to water in the transport or treatment bag.

In this invention any combinations of the stress-reducing chemicals described such as those used for oxygen generation, pH regulation, carbon dioxide regulation, salt regulation, tranquilizing chemicals, and disease and parasite control chemicals can be used in the compartment of fish transport and treatment bags.

In addition to the stress-reducing compounds stated, compounds that filter or adsorb toxic chemicals in the water of fish transport and treatment bags are within the scope of this invention. Compounds such as charcoal can be placed in the compartment of fish transport and treatment bags to adsorb toxins and excessive nutrients and wastes in the water.

A special application of the subject invention is its use to isolate and treat stressed and diseased fish. A treatment bag can be designed to treat various stress conditions that fish encounter. When individuals acquire new fish there is often justified concern that these fish may have diseases and parasites that will infect their resident fish once the new fish are introduced with them. Utilizing this invention, fish can be isolated in a plastic treatment bag that will deliver antibiotic chemicals from the bag compartment 3 to the water in the bag which will kill fish pathogens and parasites. When purchased, fish can be kept in the treatment bag for the required time known to the art to kill pathogens and parasites and then placed in an aquarium with other fish. Also, if individual fish are observed to be diseased in an aquarium, they can be removed and placed in a treatment bag designed to attack the causative pathogen and subsequently returned to their original environment.

This invention has great utility in the transport of fish from the pet store to home-and office-aquaria and from fish producers to fish distributors. It will greatly reduce the shock of this transition which often results in fish debilitation or death. Fish transport bags can be fabricated that will provide optimum oxygen, pH, ammonia concentrations (nitrites and nitrates), and carbon dioxide levels for transport.

It is not intended that the above described technology be confined to plastic fish bags. It is within the scope of this invention that compartmentalized stress-reducing chemicals can be compartmentalized in other transport media for fish such as fish tanks and containers.

### EXAMPLE 1

Increase Longevity of Minnows Stored in Compartmentalized Plastic Bags Containing Stress-Reducing Chemicals.

Plastic bags were manufactured according to this invention and tested for their ability to extend the survival of fish placed in them. One gallon self-sealing plastic food storage bags were modified according to this invention by placing stress-reducing compounds in the bottom of the bag and sequestering them in a porously sealed compartment (FIGS. 1, 2, 3). The survivability of fish in bags modified according to this invention was compared with survivability in regular plastic bags.

Minnows (2-6 cm) were procured from a local aquaculture operation (Zett's Tri-State Fish Farm and Hatchery, Inwood, W.Va.). Groups of five minnows were added to two different bag types—control bags to which only water was added and treatment bags to which two stress-reducing chemicals was added. The treatment bags were manufactured by placing methylene blue and salt at the very bottom of food storage bags (Hefty Bags®) and making a porous seal above them as in the invention description (FIGS. 1,2,3). The seal was made by inserting a row of metal prongs, spaced 1 inch apart, into the bottom of the bag on the inside, then applying a seal over them using a heat sealer. With the prongs preventing the fusion of one side of the bag to the other, but allowing it between them, pores (0.75-1.2 mm in diameter) were created between the bag compartment and the bag interior at one-inch intervals along the length of the seal.

The stress-reducing compounds were added to the compartment so as to deliver a specified dose suitable for the addition of 1 L of water to the bag. Fill lines were drawn on each bag at a distance from the bottom determined to be consistent with the addition of precisely 1 L of water. Suggested rates for addition of the stress-reducing compounds (methylene blue and salt) for aquaculture disease control are generally 2-4 ppm and 1 tbsp./5 gal., respectively. These rates were converted to amounts per liter to determine the appropriate amounts to be added to the treatment bag, yielding 4 mg/L for methylene blue and 0.78 g/L for salt.

Groups of five bags were tested for each bag type. Water was first added to the fill line. Fish were then introduced and headspace was filled with pure oxygen using a regulated oxygen tank. Bags were stored at room temperature and daily mortality observations were recorded. Survivorship of the minnows placed in the bags containing the stress-reducing compounds according to this invention was over 90% greater than that in the control bags containing only water after 84 hours. The following graph illustrates that 60.7% of the fish survived in stress reducing bags as compared to 3.8% in the control bags after 84 hours.

[image]

We claim:

1. A packaging system for transporting and treating fish which comprises a thermoplastic closable bag with a compartment that contains fish stress-reducing chemicals and a porous interface between said compartment containing fish stress-reducing chemicals and said thermoplastic closable bag that allows the flow of water and chemicals between said compartment and said thermoplastic closable bag.

2. The packaging system as recited in claim 1, wherein said means for flowing said water and chemicals from said compartment to said thermoplastic closable bag is a porous interface between said compartment and said thermoplastic closable bag with a pore size greater than 2 μm.

3. The package system as recited in claim 1, wherein said stress-reducing chemicals are oxygen generating chemicals, pH regulating chemicals, carbon dioxide regulating chemicals, ammonia regulating chemicals, nitrite regulating chemicals, salt regulating chemicals, fish tranquilizing chemicals, fish disease controlling chemicals, water purifying chemicals, and mixtures thereof.
